(19) United States
(12) Patent Application Publication
(10) Pub. No.: US 2005/0016905 A1
(43) Pub. Date: Jan. 27, 2005

(54) Fuel purifier

(76) Inventor: Kent Lindow, La Verne, CA (US)

Correspondence Address: Lewis M. Brande, Esq., 5976 Falling Tree Lane, Alta Loma, CA, 91737, US

(21) Appl. No.: 10/623,917

(22) Filed: Jul. 21, 2003

(51) Int. Cl. B01D 17/00

(52) U.S. Cl. 210/120; 210/175; 210/320; 210/519

(57) ABSTRACT

This invention describes a fuel purifier that is generally an elongated hollow cylinder. The fuel purifier has a fuel inlet, a fuel outlet, an air bleed or priming means located on the top cap of the fuel purifier, a collection sump exit located on the bottom cap of the fuel purifier. The fuel is direct against a bifurcating plate that starts the initial separation of the contaminants of the fuel. The fuel then passes through a first and second perforated plate that further causes contaminants to separate out of the fuel suspension, and eventually collect in the collecting sump exit. The fuel impacts against a separator plate, where the separator plate causes even further separation of the contaminants. The fuel fills the fuel purifier and collects in an angled collector plate which directs the purified fuel to the fuel outlet.

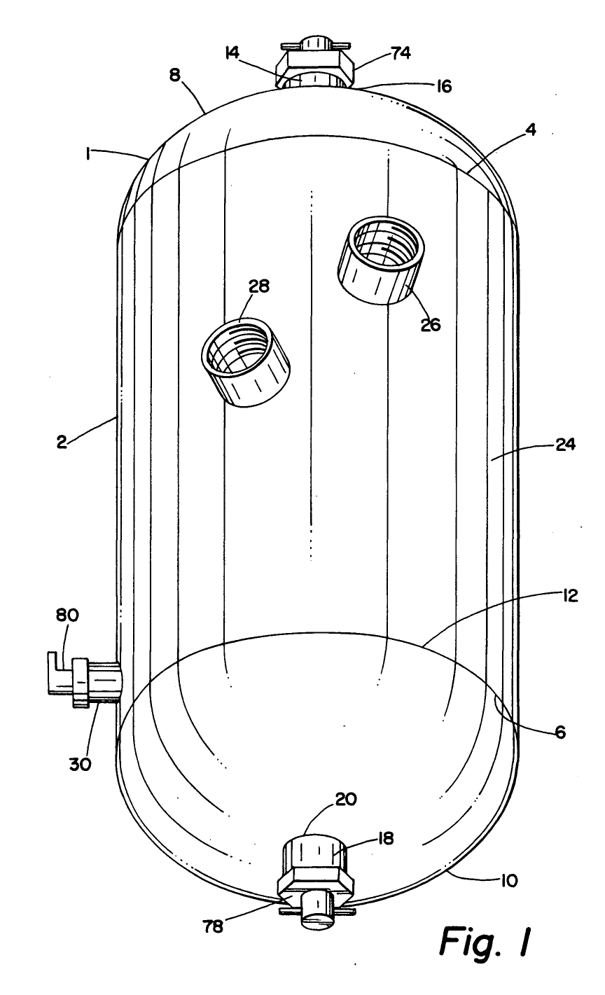

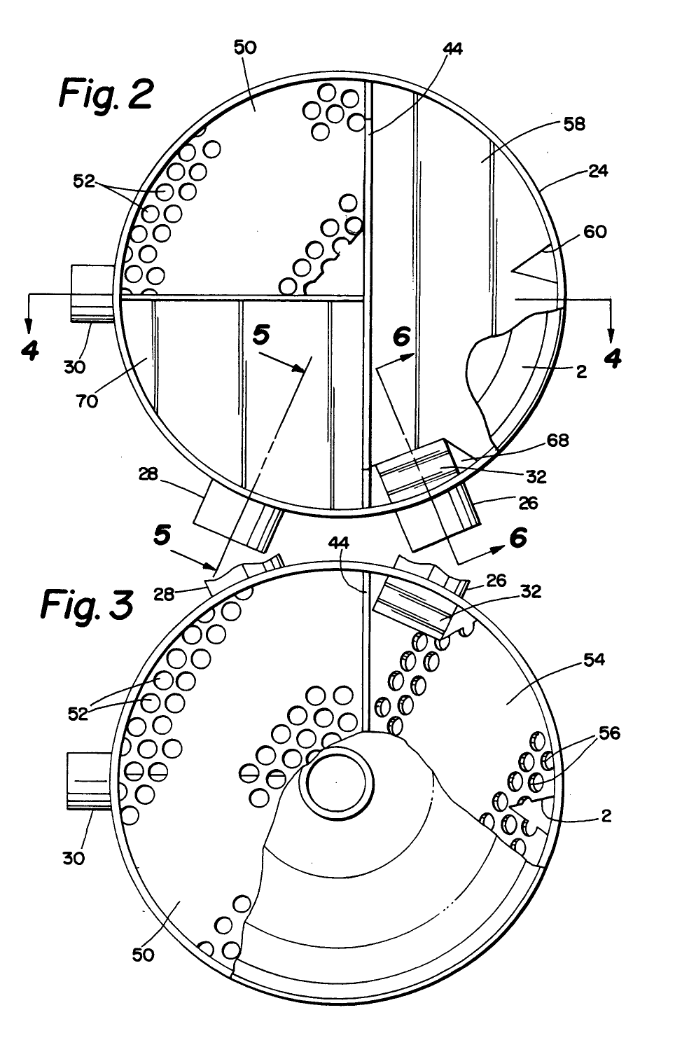

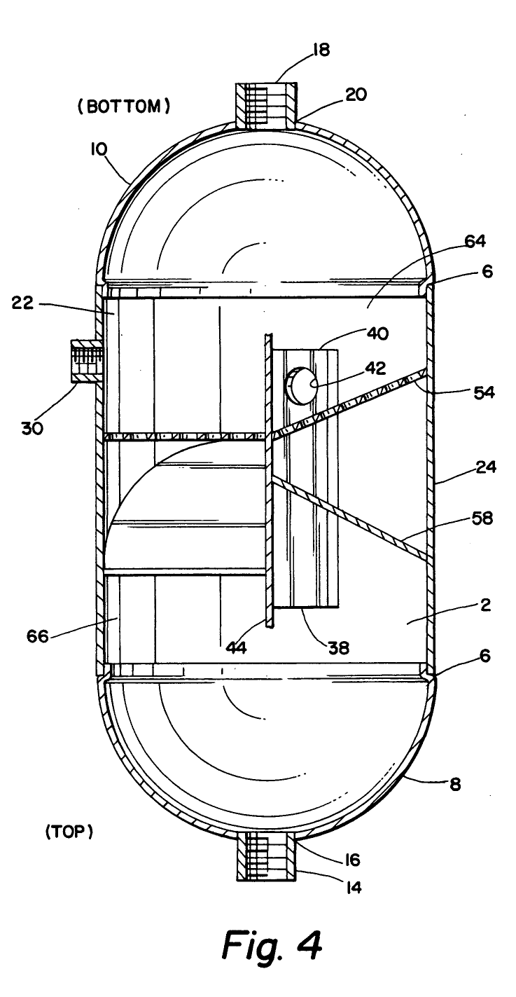

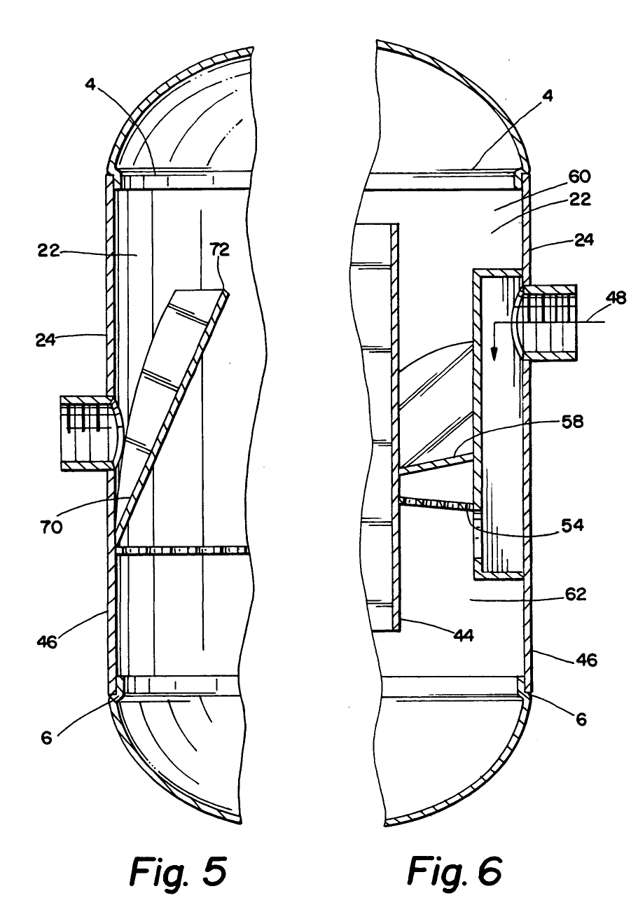

### 1. BACKGROUND OF THE INVENTION

Ever since there has been a need to purify liquids, there has been a need to filter and purify liquids, particularly petroleum based liquids. In early days, lamp oils were based on animal sources, requiring the oils to be extracted from animal fat by “rendering down” or heating the fat to extract the oils. The particulate matter was then separated from the oil by passing the mixture through cheesecloth (or the like) to separate the oil from the sediment.

More recently, petroleum based products are commonly used in a variety of ways to fuel engines, to light burners, to heat homes, etc. A need was created to separate impurities such as water, sediment, etc. from the fuel to prevent poor combustion of the fuel by internal combustion engines. This need for purification of fuels continues to the present day.

The modern internal combustion engines are more susceptible to damage by impurities in the fuel than their predecessors, because the mechanical components within the fuel delivery system are easily damaged by sediment and water.

Fuels or other hydrocarbon distillates, such as jet fuel (JP-4, JP-7), kerosene, gasoline, diesel fuel (JP-8), as well as heating oil (used mainly in the East for heating furnaces) begin to degrade over time due to the intrusion of microbiological contamination and fungi, which grow in an interface layer between the fuel and water, where heat and light, and the fuel create a very amenable environment for growth of the contamination.

The problem is even further compounded by diesel fuels, which by nature are more viscous and prone to colloidal suspension of water, particulate matter, and even a waxy constituent that becomes prominent when temperatures drop below a “cloud point”. These suspensions adversely affect the ability of the fuel pumps to deliver fuel, and may even block the existing fuel filters, preventing adequate fuel delivery. This becomes most prominent in colder weather, where the waxy constituent of the diesel fuel precipitates out of the colloidal suspension. It is very common to add heaters to the fuel conditioners, or purifiers, to attempt to reduce the problem with this waxy constituent of the diesel fuels.

It is imperative that the fuel that is injected into the engines be free of water and other contamination.

A variety of fuel purifiers are currently employed by the automotive diesel industry that remove particulate matter from the suspension, and assist in forcing the water from the suspension, making the fuel capable of providing a thermodynamic efficiency more closely approaching the theoretical maximum BTU output for the fuel in question.

### 2. DESCRIPTION OF THE PRIOR ART

U.S. Pat. No. 3,633,755 by Chaneton, dated Jan. 1^{th}, 1972, discloses a “Strainer or Filter for Cleaning Fluids”. This invention uses a paper or the like filtering element that removes the undesirable particles from the fuel prior to injection into the engine. The present invention does not use any filtering elements as such.

U.S. Pat. No. 4,081,373 by Rozniecki, dated March 28^{th}, 1978, discloses a “Mechanism for Exhausting Impurities from Engine Fuel”. This invention has a cyclone action that imparts centrifugal forces onto an impure fluid, causing the depositing of the heavier particles near the upper portion of the device, where the heavier impurities settle out of the stream. The device also comprises a water coalescer containing a porous media of hydrophobic material. The water droplets collect on the water coalescer and are continuously siphoned off, and discharged from the system. The invention also has a siphon, that allows for the removal of the impurities that collect at the bottom of the filter.

U.S. Pat. No. 4,372,847 by Lewis, dated Feb. 8^{th}, 1983, discloses a Fuel Filter Assembly and Cartridge”. This invention has an outer filter that separates particulate matter from diesel fuel, and an inner annular filter that separates and precipitates water into a reservoir that is located at the bottom of the fuel filter cartridge. The fuel enters and passes through the outer filter, which has perforations, that cause the water to coalesce and precipitate out of the fuel. The fuel then passes through an annular screen that filters the solid particulate matter. The purified fuel then passes through a tube and is conducted out of the filter and towards the internal combustion engine.

U.S. Pat. No. 4,714,552 by Tabor, dated Dec. 22^{nd}, 1987, discloses a “In-Line Fluid Filtering Devices and Disk-Filters Useful in Such Devices”. This invention is generally used to filter water in order to use the purified water for irrigation. The water passes through an inlet and ultimately through a series of disks, where the disks are compacted together. The disks constrained to maintain a cylindrical pattern, but are loose enough to allow water to pass through. The particles within the water collect on the disk surface, and are ultimately cleaned by reverse flow of the filter, allowing the sediment to pass through a back-flow valve. The filter would then resume normal operation.

U.S. Pat. No. 4,757,618 by Mihalov, dated Jul. 19^{th}, 1988, discloses a Ship System for the Recovery of Fuel Oil from Sludge Removed by Flashing of Heavy Oil Purifiers “. This patent describes a ship system for recovery of fuel oil from sludge removed by flushing of heavy oil purifiers. This system uses a settling tank connected to a condenser by gate valves pipe conduits and fuel pump(s). The sludge in the settling tank is heated with a steam heating coil, causing evaporation of low boiling petroleum fractions. These petroleum fractions are condensed, i.e. distilled, and collected in a condenser.

U.S. Pat. No. 4,961,845 by Dawson et al., dated Oct. 9^{th}, 1990, discloses a “Apparatus and Method for Filtering Particulate Matter from Dielectric Fluids”. This invention operates by giving an electrostatic charge to a dielectric liquid, and then allowing the fluid to pass axially through perforations in flat plates. The impurities are captured because the particles become clumped together because they have opposing charges. The resulting aggregate particle is captured by a porous filter.

U.S. Pat. No. 4,976,852 by Janik et al., dated Mar. 28^{th}, 1978, discloses a “Fuel Filter”. This invention incorporates a removable filter section, a water inlet and outlet with a water sensor, and a water drain cock. The fuel enters and is sprayed on the top of the filter, where the impact causes the water droplets to grow, and then separate out of the fuel. The water droplets will then fall and be separated by a barrier that prevents the water from being re-mixed into the fuel. The water falls to the bottom of the filter where it is later removed.

U.S. Pat. No. 4,986,907 by Montemayor Uzeta, dated Jan. 22^{nd}, 1991 discloses a “Fuel Purifying Apparatus”. This invention discloses a hollow enclosed cylinder that has a fuel flow conduit that directs the fuel at an angle to a metal deflector plate, where the angled flow direction will cause the contaminants in diesel fuel to be forced out due to the cyclonic action of the angled fuel flow. The most obvious differences between the disclosed invention and the current application is the addition of separator plates and perforated plates internal to the fuel purifier. Current tests show that the addition of these plates further purify the fuel, substantially improving the fuel purity entering into the engine.

U.S. Pat. No. 5,510,194 by Hendricks et al., dated Apr. 23^{rd}, 1996, discloses a “Perforated Plate Filter Media and Related Products”. This invention claims an air filter that is capable of removing air contaminants down to one micron in size. The invention also discloses the process needed to create the holes in order for them to be uniform in diameter.

U.S. Pat. No. 5,534,138 by Coale, dated Jul. 9^{th}, 1996, discloses a Fuel Separator Apparatus”. This invention discloses a filter that has frustoconically shaped plates that cause the fuel mixture into a turbulent and circular flow pattern. This centrifuge-like flow pattern is interrupted by a vertical plate that causes forced separation of the impurities and contaminants from the fuel mixture.

U.S. Pat. No. 6,042,722 by Lenz, dated Mar. 28^{th}, 2000, discloses a “Apparatus for De-Watering and Purifying Fuel Oils and Other Liquids”. The contaminated fuel is drawn from a fuel tank and passed into a separator. The water stays at the bottom of the separator and is drained off. The fuel is drawn upwards and passes through a filter which removes any solid impurities at which point the cleansed fuel is sent back to the original fuel tank. This process may be repeated many times. Water collects on a series of aluminum plates where the coalesced water droplets become large enough to then be drawn down to the bottom of the filter by gravity. This filter works specifically on a low pressure system to prevent turbulent flow.

### 3. BRIEF DESCRIPTION OF THE DRAWINGS

1. Figure one shows a perspective view of the fuel purifier.

2. Figure two shows a cross sectional top view.

3. Figure three shows a cross sectional bottom view.

4. Figure four shows a cross sectional side view.

5. Figure five shows a cross sectional view of the fuel outlet.

6. Figure six shows a cross sectional view of the fuel inlet.

### 4. DETAILED DESCRIPTION

With respect to figure one, a fuel purifier (1) is shown. The fuel purifier (1) has a cylindrically shaped tubular body (2). The cylindrically shaped tubular body (2) has a top (4) and bottom (6). A top cap (8) that is generally a spherically shaped shell is attached to the top (4), while a bottom cap (10) also generally a spherically shaped shell, is attached to the bottom (12) of the cylindrically shaped tubular body (2). The top cap (8) has a first internally threaded boss or priming inlet (14) attached to the apex (16) of the top cap (8). The bottom cap (10) has a second internally threaded boss or collecting sump exit (18) attached to the bottom (20) of the bottom cap (10). The top cap (8) and the bottom cap (10) are attached to the cylindrically shaped tubular body (2) creating a hollow cavity (22) therein. The first and second internally threaded bosses (14, 18) allows communication with the hollow cavity (22). The first internally threaded boss (14) generally has a priming means, or an air bleed means to allow the fuel purifier (1) to be primed before use, and to allow the bleeding of trapped air within the system the priming means or air bleed means may be a stop cock (74) or a simple threaded bolt, common in the industry. The second internally threaded boss (18) generally has a stop cock or drainage valve (78), common in the industry, threadably attached to said collecting sump exit (18) to allow drainage of contaminants collected in the bottom (20) of said bottom cap (10).

The cylindrically shaped tubular body (2) has an exterior surface (24). A third internally threaded boss, or fuel inlet, (26) is attached to the exterior surface (24) of the fuel purifier (1). A fourth internally threaded boss, or fuel exit, (28) is attached to the exterior surface (24) of the fuel purifier (1). A fifth internally threaded boss or sensor port (30), is attached to the exterior surface (24) of the fuel purifier (1). The sensor port may have a heating element (80) threadably attached or a sensor (82) threadably attached. The sensor (82) providing either an auditory or visual signal to the operator that maintenance is necessary. The third, fourth and fifth (26, 28, 30) internally threaded bosses, allow communication with the hollow cavity (2) of the fuel purifier (1). This embodiment of the fuel purifier (1) shows that the fuel inlet (26), and the fuel exit (28) positions are biased towards the top (4) of the cylindrically shaped tubular body (4), with the fuel inlet (26) positioned slightly higher than the fuel exit (28) which assists in preventing any contaminants from exiting the fuel purifier (1). The fuel inlet (26) is attached to a fuel line (not shown) that communicates with the stored fuel used by the internal combustion engine. The fuel exit (28) is attached to a fuel line (not shown) that directs the fuel to the engine. There may be additional filters between the fuel purifier and the engine.

A fuel transmission conduit (32) has a hollow portion therein defined. (34). The fuel transmission conduit (32) has an inlet (36) located co-incident with the fuel inlet (26) of the fuel purifier (1). The fuel transmission conduit (32) has a top (38) and a bottom (40). The inlet being biased towards the top (38) of the fuel transmission conduit (32). The bottom (40) of the fuel transmission conduit (32) has a fuel discharge exit (42) defined therein. The fuel discharge exit (42) allows the fuel to remain in generally the same flow direction (i.e. parallel direction or same vector orientation) with the inlet of the fuel transmission conduit (32). Generally the fuel enters the fuel transmission conduit (32) from the fuel inlet (26) and makes an immediate 90 downward directional turn. The fuel is then directed towards the bottom (40) of the fuel transmission conduit (32) where the fuel discharge exit (42) is located. The fuel discharge exit (42) generally directs the fuel towards the center of the hollow cavity (22) of the fuel purifier (1).

Located within the hollow cavity or separating chamber (22) of the fuel purifier (1) is a bifurcating plate (44). The bifurcating plate (44) is attached to an interior surface (46) of the cylindrically shaped tubular body (2) creating a first chamber (64) and a second chamber (66) therein, where the first chamber (64) is located on the fuel inlet side (26) and the second chamber (66) is located on the fuel exit (28) side of the fuel purifier (1). The bifurcating plate (44) is orientated so the fuel entering through the fuel discharge exit (42) impacts the bifurcating plate (44) at an angle less than 90 degrees from the flow direction (48). The angle between the flow direction (48) and the bifurcating plate (44) is optimized to allow the maximum flow velocity while maximizing the impact force of the fuel. The purpose of the bifurcating plate (44) is to force solid and liquid impurities to separate out of the fuel mixture. After impacting the bifurcating plate (44) the fuel is directed towards the bottom (20) of the bottom cap (10) where it puddles and then starts to fill the fuel purifier (1). The bifurcating plate (44) may split the fuel purifier (1) in half, or as in the case of this embodiment, be biased towards the fuel inlet (26), thereby creating a volumetric split of approximately 60-40 percent, where the 60 percent volume bias is towards the fuel exit (28).

A first perforated plate (50) is biased towards the bottom (6) of the cylindrically shaped tubular body (2). The first perforated plate (50) has holes (52) defined therein, where the holes (52) are of at least 4 percent to seven and one half percent (4%-7.5%) of the diameter of the tubular body, and the first perforated plate (50) having a porosity of approximately forty seven to seventy two percent (47%-72%). The orientation of the first perforated plate (50) is generally parallel with the bottom (6) of the cylindrically shaped tubular body (2). The first perforated plate (50) is located on the fuel exit (28) side of the cylindrically shaped tubular body (2).

A second perforated plate (54) is biased towards the bottom (6) of the cylindrically shaped tubular body (2). The second perforated plate (54) has holes (56) defined therein, where the holes (56) are at least 4 percent to seven and one half percent (4%-7.5%) of the diameter of the tubular body, and having a porosity of approximately forty seven to seventy two percent (47%-72%), the second perforated plate (54) being generally parallel with the bottom (6) of the cylindrically shaped tubular body (2). The second perforated plate (54) is located on the fuel inlet (26) side of the cylindrically shaped tubular body (2). The second perforated plate (54) is positioned above the fuel discharge exit (42) of the fuel transmission conduit (32), allowing unimpeded flow of the fuel against the bifurcating plate (44). The second perforated plate (54) may be located essentially planar to the first perforated plate (50) and possibly spaced at a planar distance from the first perforated plate (50).

The holes in the first perforated plate (50) and the second perforated plate (54) may be defined as a polygon having “n” sides where “n” is no less than four (4), but as “n” approaches infinity the polygon becomes circular in shape.

A first separator plate (58) is located on the fuel inlet side (26) of the cylindrically shaped tubular body (2). It is positioned above and generally parallel to the second perforated plate (54). The first separator plate (58) is attached to the cylindrically shaped tubular body (2) and the bifurcating plate (44) creating an upper inlet portion (60), and a lower inlet portion (62) of the first chamber (64). The first separator plate (58) has passages (68) defined therein (60), wherein the passages (68) allow communication between the upper inlet portion (60) and the lower inlet portion (62) of the first chamber (64).

Located on the fuel exit (28) side of the fuel purifier (1) is an angled collecting plate (70). The angled collecting plate (70) is attached to the bifurcating plate (44) and the cylindrically shaped tubular body (2) of the fuel purifier (1). The angled collecting plate has an upper edge (72). The orientation of the angled collecting plate (70) is such that the upper edge (72) is biased towards the top (4) of the cylindrically shaped tubular body (2) and thereby directs the fuel towards the fuel exit (28).

The fuel is a colloidal suspension of water and diesel fuel. Fuel enters the fuel purifier (1) via the fuel inlet (26) and is directed through the fuel transmission conduit (32) downwards to then impact the bifurcating plate (44). The fuel initially starts to collect in the bottom cap (10). As more fuel enters the fuel purifier (1) the fuel then will impact the first and second perforated plates (50, 54). The first and second perforated plates (50, 54) cause water and sediments held in suspension to coalesce out. As the fuel continues to enter into the fuel purifier (1), it eventually reaches and will then impact the first separator plate (58). The first separator plate (58) is essentially a solid plate that provided a large surface area for the water dispersed within the colloidal suspension to adhere onto. The water tends to adhere to the first separator plate (58) because the water in suspension is essentially polar and tends to be chemically attracted to metallic substances. This being the case, the water essentially adheres to the first separator plate (58) and singular water molecules will ultimately combine with each other to become larger water droplets, thereby becoming heavier than the surrounding fuel, and then drop to the bottom cap (10) of the fuel purifier (1), and eventually be removed through the collecting sump exit (18). Generally the second internally threaded boss, or collecting sump exit (18), has a drain valve (not shown) attached to allow the sediments and water that have collected to be drained.

The fuel fills the first chamber (64) and the second chamber (66). Fuel will eventually spill over the upper edge (72) of the angled collecting plate (70), and be directed towards the fuel exit (28) and ultimately the internal combustion engine.

Although the foregoing includes a description of the best mode contemplated for carrying out the invention, various modifications are contemplated.

As various modifications could be made in the constructions herein described and illustrated without departing from the scope of the invention, it is intended that all matter contained in the foregoing description or shown in the accompanying drawings shall be interpreted as illustrative rather than limiting.

1. A fuel purifier comprising:
a. a hollow cylindrically shaped body having a top cap and a bottom cap, the top cap and the bottom cap being attached to the hollow cylindrically shaped body, said top cap having an apex, and said bottom cap having a bottom;
b. said hollow cylindrically shaped body having a first internally threaded boss, or priming inlet, a second internally threaded boss, or collecting sump exit, a third internally threaded boss, or fuel inlet, a fourth internally threaded boss, or fuel outlet, a fifth internally threaded boss or heating connector means, said priming inlet being located on said apex of said top cap, said collecting sump exit being located on said bottom of said bottom cap, said fuel inlet, said fuel outlet, and said heating connector means being located on an exterior surface of said hollow cylindrically shaped body;
c. said priming inlet having a priming means or air bleed means threadably attached thereto, said collecting sump exit having a drainage valve means threadably attached thereto;
d. a bifurcating plate, said bifurcating plate being attached to an interior surface of said hollow cylindrically shaped body;
e. a fuel inlet, said fuel inlet communicating with a fuel transmission conduit, said fuel transmission conduit having an inlet and an outlet, said inlet communicating with said fuel inlet, said outlet of said fuel transmission conduit angularly directing fuel against said bifurcating plate, causing contaminant separation of the fuel;
f. said bifurcating plate creating a first chamber and a second chamber, said first chamber being located in the proximity of said fuel inlet, and said second chamber being located in the proximity of said fuel exit;
g. a first separating means being positionally fixed towards a bottom of said hollow cylindrically shaped body and located in said second chamber of said hollow cylindrically shaped body, a second separating means being positionally fixed towards said bottom of said hollow cylindrically shaped body and being located in said first chamber of said hollow cylindrically shaped body;
h. a first separator plate, said first separator plate being attached to said interior surface of said hollow cylindrically shaped body and being located in said first chamber, said first separator plate creating an upper inlet portion and a lower inlet portion, said first separator plate additionally having holes defined therein allowing communication between said upper inlet portion and said lower inlet portion; and
i. an angled collecting plate, said angled collecting plate being located in said second chamber, said angled collecting plate being attached to said interior surface of said hollow cylindrically shaped body and said bifurcating plate, said angled collecting plate having an upper edge, said upper edge being positioned towards an upper portion of said bifurcating plate and directing fuel towards said outlet of said hollow cylindrically shaped body.

2. The fuel purifier of claim 1 wherein;
a. said first separating means being a first perforated plate, said perforated plate having holes defined therein, said holes allowing fuel flow therethrough, and a means for contaminants to collect and eventually settle towards said bottom of said bottom cap and to be removed through said collecting sump exit; and
b. said second separating means being a second perforated plate, said perforated plate having holes defined therein, said holes allowing fuel flow therethrough, and a means for contaminants to collect and eventually settle towards said bottom of said bottom cap and to be removed through said collecting sump exit.

3. The fuel purifier of claim 1 wherein said priming means is a stop cock.

4. The fuel purifier of claim 1 wherein said drainage valve means is a stop cock.

5. The fuel purifier of claim 2 wherein said holes having a diametrical formula that is a ratio of the tubular body diameter, said ratio being between four percent and seven and one half percent.
